(19) United States
(12) Patent Application Publication
(10) Pub. No.: US 2015/0324312 A1
(43) Pub. Date: Nov. 12, 2015

(54) ALLOCATING LANES OF A SERIAL COMPUTER EXPANSION BUS AMONG INSTALLED DEVICES

(71) Applicant: International Business Machines Corporation, Armonk, NY (US)

(72) Inventors: Steven C. Jacobson, Mebane, NC (US); Loc X. Nguyen, Raleigh, NC (US); Luke D. Remis, Raleigh, NC (US); Timothy R. Tennant, Durham, NC (US)

(73) Assignee: International Business Machines Corporation, Armonk, NY (US)

(21) Appl. No.: 14/273,666

(22) Filed: May 9, 2014

Related U.S. Application Data
(63) Continuation of application No. 14/273,076, filed on May 8, 2014.

(51) Int. Cl. G06F 13/40; G06F 13/42

(52) U.S. Cl. CPC G06F 13/4022; G06F 13/4221; G06F 13/4018

(57) ABSTRACT

A method includes a supervisory controller within a computer identifying a plurality of PCIe devices installed within the computer and identifying one or more configurable link width for each of the identified PCIe devices, wherein each of the identified PCIe devices is determined to be installed in a particular PCIe slot. The method further includes the supervisory controller granting a higher priority to a first one of the PCIe devices than to a second one of the PCIe devices, and the supervisory controller controlling the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

### CROSS-REFERENCE TO RELATED APPLICATIONS

This application is a continuation of U.S. patent application Ser. No. 14/273,076 filed on May 8, 2014, which application is incorporated by reference herein.

### BACKGROUND

1. Field of the Invention

The present invention relates to the control and operation of a serial computer exapansion bus within a computer.

2. Background of the Related Art

Peripheral Component Interconnect Express (PCIe) is a high-speed serial computer expansion bus standard using a point to point topology. A group of serial communication lanes form a link connecting two devices, such as connecting a processor to one or more compatible expansion devices. A PCIe link may include from one to thirty-two serial communication lanes. Where the PCIe link is more than one lane, data is striped across the lanes of the link. PCIe slots and expansion card edge connectors may have various widths, such ×1, ×2, ×4, ×8, ×16 or ×32. Unfortunately, installing an ×8 PCIe expansion card device in an ×16 PCIe slot means that half of the lanes to the PCIe slot will go unused.

### BRIEF SUMMARY

One embodiment of the present invention provides a method comprising a supervisory controller within a computer identifying a plurality of PCIe devices installed within the computer and identifying one or more configurable link width for each of the identified PCIe devices, wherein each of the identified PCIe devices is determined to be installed in a particular PCIe slot. The method further comprises the supervisory controller granting a higher priority to a first one of the PCIe devices than to a second one of the PCIe devices, and the supervisory controller controlling the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

### BRIEF DESCRIPTION OF THE SEVERAL VIEWS OF THE DRAWINGS

FIG. 1 is a block diagram of a system for allocating serial communication lanes among a plurality of PCIe devices.

FIG. 2 is a block diagram of a system for allocating serial communication lanes among a plurality of PCIe devices.

FIG. 3 is a flowchart of a method in accordance with one embodiment of the present invention.

### DETAILED DESCRIPTION

One embodiment of the present invention provides a method comprising a supervisory controller within a computer identifying a plurality of PCIe devices installed within the computer and identifying one or more configurable link width for each of the identified PCIe devices, wherein each of the identified PCIe devices is determined to be installed in a particular PCIe slot. The method further comprises the supervisory controller granting a higher priority to a first one of the PCIe devices than to a second one of the PCIe devices, and the supervisory controller controlling the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

The supervisory controller is an out-of-band microcontroller that may be embedded on the motherboard of a computer, such as a server. The supervisory controller provides an interface between system management software and the hardware of the computer. The computer may include various types of sensors that monitor parameters such as computer hardware configuration, component temperatures, cooling fan speeds, and power status, and provide such parameters to the supervisory controller. Accordingly, the supervisory controller may monitor the operation of various subsystems of the computer and may control the operation of certain components of the computer. In one example, the supervisory controller may be a baseboard management controller (BMC).

A given computer will have a fixed number of serial communication lanes available to support communication between the processor and the installed PCIe devices. When the PCIe devices installed in the computer are capable of making use of more serial communication lanes than are available, the methods of the present invention are able to determine how to best allocate the available serial communication lanes to the PCIe devices. The number of serial communication lanes that are allocated to a PCIe device may be referred to as the “link width.” Similarly, each PCIe device may be configurable at several different link widths, but perhaps not just any link width. For example, a first PCIe device may be configured with a link width of 16 serial communication lanes (×16), a link width of 8 serial communication lanes (×8), or a link width of 4 serial communication lanes (×4). Accordingly, the first PCIe device in this example has a maximum link width of 16 serial communication lanes. If a second PCIe device is given higher priority and was previously allocated fewer than its maximum link width, the supervisory controller may reduce the link width of the first PCIe device from ×16 to ×8 and increase the link width of the second PCIe device by up to 8 serial communication lanes. The amount by which the supervisory controller may reduce or increase the link width of a PCIe device is constrained to the configurable link widths of the relevant PCIe devices. In other words, any particular PCIe device might be configurable at the link widths ×16, ×8 and ×4, but not at ×12.

In one option, the supervisory controller may identify the plurality of PCIe devices and identify one or more configurable link width for each of the identified PCIe devices by reading the vital product data of the PCIe devices. Vital product data that describes the PCIe device is typically stored in non-volatile memory that is physically located on the PCIe device. When the PCIe device is installed in a PCIe slot, the supervisory controller can obtain the vital product data and use that data to determine how to allocation serial communication lanes among the installed PCIe devices. In one embodiment, the supervisory controller may control the allocation of serial communication lanes during boot of the computer. Furthermore, the supervisory controller may run a basic input output system (BIOS software) that identifies the plurality of PCIe devices and controls the allocation of serial communication lanes.

The supervisory controller may control the allocation of at least some of the serial communication lanes from the processor to the plurality of PCIe devices by providing a signal on a select line to a multiplexer or switch. The multiplexer has serial communication inputs from the processor and serial communication outputs to the PCIe slots where the PCIe devices are installed. Typically, there will be fewer serial communication lanes from the processor to the multiplexer than from the multiplexer to the PCIe slots. In response to a signal or command from the supervisory controller, the multiplexer provides communication between the inputs and the appropriately selected outputs so that the intended lane widths are provided to each PCIe device. Furthermore, the supervisory controller may dynamically change the allocation of serial communication lanes in response to changing conditions (such as increasing temperature in the location of a PCIe device), configurations (such as replacing a low performance PCIe device with a higher performance PCIe device), or performance requirements (a new workload placed on a PCIe device). For example, the supervisory controller may detect a change in the PCIe devices that are installed in the computer, and change the allocation of serial communication lanes in response to the change in the PCIe devices.

In various embodiments, the supervisory controller may obtain vital product data from the installed PCIe devices and allocate the serial communication lanes to the installed PCIe devices in response to the vital product data (VPD). Typically, the vital product data will identify the type of device, such as a network communication adapter, graphics card, or other input/output device. Furthermore, the vital product data may identify the various configurable link widths that the device may be capable of using. The vital product data may include many other details that might be used to determine a priority for the device and allocate lanes accordingly. In one example, a method of the present invention may determine that the vital product data indicates that first and second installed PCIe devices provide a redundant resource, determine that the vital product data indicates that the first PCIe device can provide greater performance than the second PCIe device, and allocate more serial communication lanes to the first PCIe device than to the second PCIe device. In another example, a method of the present invention may determine that the vital product data indicates that first and second installed PCIe devices provide a redundant resource, determine that the vital product data indicates that the first PCIe device can provide greater performance than the second PCIe device, and give higher priority to allocation of serial communication lanes to the first PCIe device than to the second PCIe device. More specifically, the first and second PCIe devices may both be Ethernet Adapters.

In one option, a method of the present invention may include detecting the presence of heat-generating devices in the computer, wherein the heat-generating devices are selected from a processor, memory and hard disk drive. The method may then determine whether a first PCIe device is installed in a PCIe slot having a position directly downstream in an air flow direction from one or more of the heat-generating devices, and, in response to determining that the first PCIe device is installed downstream of one or more of the heat-generating devices, reducing a number of serial communication lanes allocated to the first PCIe device and increasing a number of serial communication lanes allocated to a second PCIe device installed in a PCIe slot that is not directly downstream in the air flow direction from one or more of the heat-generating devices.

In another option, a method of the present invention may include detecting the presence of heat-generating devices in the computer, wherein the heat-generating devices are selected from a processor, memory and hard disk drive. The method may then determine whether a first PCIe device is installed in a PCIe slot having a position in a downstream air flow direction from the heat-generating devices, and use vital product data from the heat-generating devices to predict whether the first PCIe device will receive air flow having a temperature greater than a temperature setpoint as a result of the operation of one or more of the heat-generating devices. In response to determining that the first PCIe device will receive air flow having a temperature greater than the temperature setpoint, the method may reduce a number of serial communication lanes allocated to the first PCIe device and increase a number of serial communication lanes allocated to a second PCIe device installed in a PCIe slot where the air flow is predicted to have a temperature less than the temperature setpoint. Optionally, the method may use vital product data from the first PCIe device to determine cooling requirements of the first PCIe device.

In a further option, the method may measure the temperature of a first PCIe device in the computer, determining whether the temperature of the first PCIe device is greater than a temperature setpoint, and, in response to determining that the first PCIe device has a temperature greater than the temperature setpoint, reduce a number of serial communication lanes allocated to the first PCIe device and increase a number of serial communicaton lanes allocated to a second PCIe device. Such a method may then also include increasing a number of serial communication lanes allocated to the first PCIe device and reducing a number of serial communicaton lanes allocated to a second PCIe device in response to determining that the first PCIe device has a temperature that is now less than the temperature setpoint.

In a still further option, the method may measure the temperature of each PCIe device in the computer, identifying which of the PCIe devices has the highest temperature, and, in response to determining that a first PCIe device has the highest temperature, reduce a number of serial communication lanes allocated to the first PCIe device and increase a number of serial communication lane allocated to one or more other PCIe devices in the computer.

In an additional option, the method may detect that a first PCIe device has been throttling, and, in response to detecting that the first PCIe device has been throttling, reduce a number of serial communication lanes allocated to the first PCIe device and increase a number of serial communication lane allocated to one or more other PCIe devices in the computer.

Another embodiment of the present invention provides a computer program product comprising a computer readable storage medium having program instructions embodied therewith, where the program instructions are executable by a processor to cause the processor to perform a method. The method comprises a supervisory controller within a computer identifying a plurality of PCIe devices installed within the computer and identifying one or more configurable link width for each of the identified PCIe devices, wherein each of the identified PCIe devices is determined to be installed in a particular PCIe slot. The method further comprises the supervisory controller granting a higher priority to a first one of the PCIe devices than to second one of the PCIe devices, and the supervisory controller controlling the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

The foregoing computer program products may further include computer readable program code for implementing or initiating any one or more aspects of the methods described herein. Accordingly, a separate description of the methods will not be duplicated in the context of a computer program product.

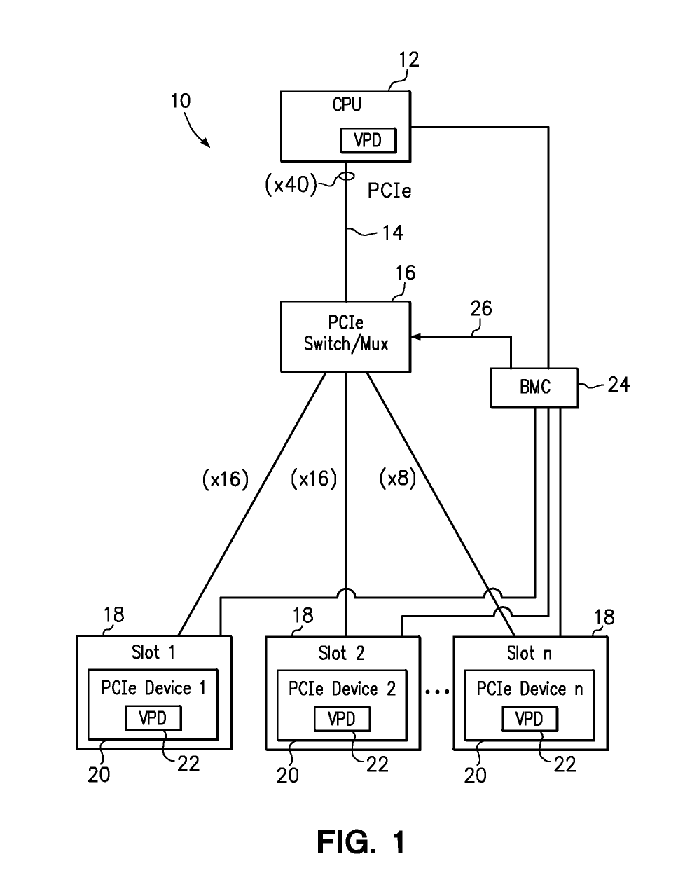

FIG. 1 is a block diagram of a system 10 for allocating serial communication lanes among a plurality of peripheral devices. The system 10 includes a processor (CPU) 12 that can communication over a peripheral component interconnect express (PCIe) bus 14. In this embodiment, the PCIe bus 14 includes 40 serial communication lanes (×40) that extend to the inputs of a PCIe multiplexer or switch 16. The PCIe multiplexer 16 is electronically coupled between the processor 12 of a computer and the PCIe slots 18 where the PCIe devices 20 are installed. A baseboard management controller (BMC) 24 controls a select line 26 to the multiplexer 16 that determines how the multiplexer configures the serial communication lanes. For example, a typical server will have a processor 12 that communicates with three PCIe slots 18 using a PCIe bus 14 having 40 serial communication lanes. In this example, it is possible to configure two PCIe devices (say, PCIe Device 1 and PCIe Device 2) with 16 lanes (×16) each and one additional PCIe device (say, PCIe Device 3) with 8 lanes (×8). However, embodiments of the invention allows the BMC 24 to control the multiplexer 16 so that any of the PCIe devices 20 may be configured with a different lane width (i.e., different number of serial communication lanes) for communication with the processor 12.

In a first embodiment, the BMC 24 may read the VPD 22 of each PCIe device 20 using a separate communication line 28 to each PCIe slot 18. If the VPD obtained from the PCIe devices indicates that there are redundant resources installed in the PCIe slots (i.e., two PCIe device of the same type, such as Ethernet adapters), then the BMC 24 may determine a priority between the PCIe devices 20. For example, if the redundant PCIe device having the higher priority is not already configured with its maximum link width, then the BMC 24 may control the multiplexer 16 to increase the number of serial communication lanes allocated to the redundant PCIe device having the higher priority and reduce the number of serial communication lanes allocated to the redundant PCIe device having the lower priority.

In a second embodiment, if the BMC 24 determines that one or more the installed PCIe devices 20 is expected to be hotter than the other installed PCIe devices, then the BMC may reallocate lanes to the PCIe device(s) expected to be cooler. For example, a PCIe device is expected to be hotter if it is physically downstream (in an airflow direction) from the processor 12 or other device that generates lots of heat. Alternatively, the BMC may measure the current temperature of the PCIe devices and allocate more/fewer lanes to one PCIe device over another. A PCIe device that is cooler is more likely to make good use of the lanes than a hotter PCIe device, since the cooler PCIe device is unlikely to throttle its performance.

“Bifurcation” refers to the division of lanes to be assigned to different devices. The processor shown has a ‘generic’ set of PCIe lanes (say 40 lanes) and knows nothing about the PCIe topology before the BIOS runs. The BIOS scans the PCIe tree looking for common devices and how to segregate or bifurcate the bus. For example, if the BIOS detects a ×16 video device in one of the PCIe slots, then the BIOS would bifurcate the PCIe lanes to allow the video device to use 16 lanes from its pool of lanes. Normally the BIOS is run each power cycle to cover the cases where someone changes Video cards, enet, storage . . . etc. Optionally, a PCIe device may be provided less than full width. For example, a ×16 card can be configured as a ×1, ×2, ×4, ×8 or ×16.

PCIe lanes may be moved, reassigned or reallocated from a hot device to a cooler device, because a hotter device will generally self-throttle and may therefore under-utilize the full-width link. For example, if an ×16 video card configures as a ×16 device, but due to poor air cooling the temperature of the video card becomes elevated such that the video card has to self-throttle. If the video card throttles to the point that the video card only runs at 50% capacity, then the video card could have provided the same performance if it had been bifurcated as a ×8 device. Accordingly, the spare ×8 lanes could be used by another PCIe device to increase its performance.

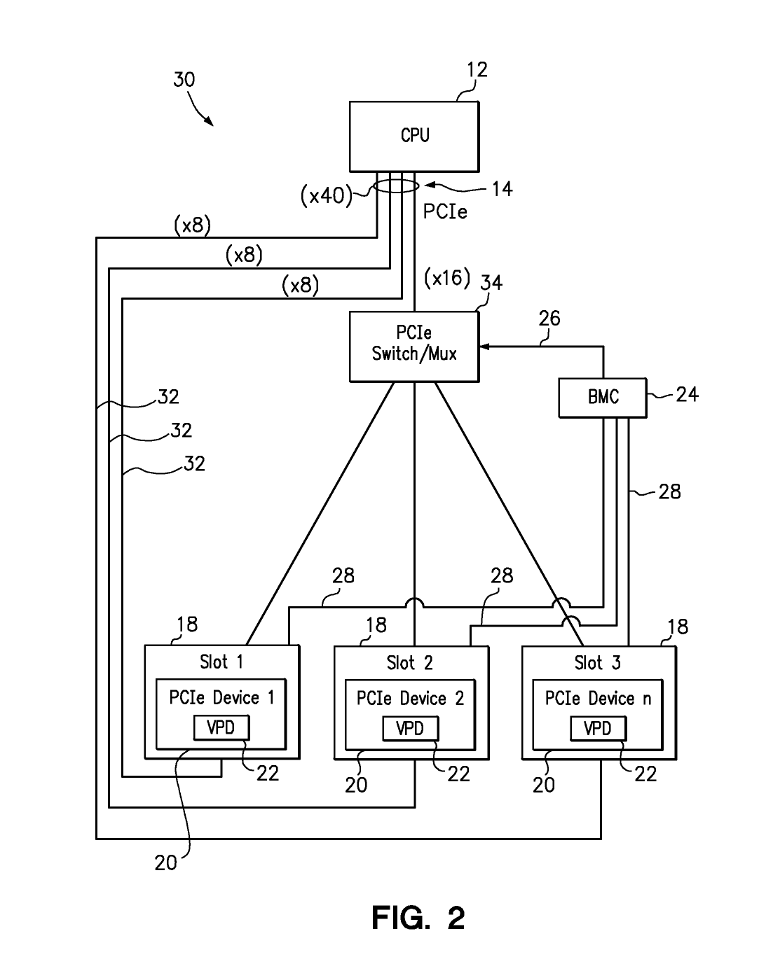

FIG. 2 is a block diagram of a system 30 for allocating serial communication lanes among a plurality of PCIe devices 20. The system 30 is similar to that of system 10 in FIG. 1, except that each of there are exactly three PCIe slots 18 that are each hardwired to 8 serial communication lanes (see lines 32). Accordingly, only the remaining lanes (i.e., 16 lanes in this example) are directed to the inputs of the PCIe multiplexer/switch 34, which otherwise operates consistent with the PCIe multiplexer/switch 16 of FIG. 1. The reduced number of serial communication lanes being directed through the PCIe multiplexer/switch 34 means that the PCIe multiplexer/switch 34 is less complex and expensive. However, the methods of the present invention may still be implemented by the BMC 24 providing a select signal 26 to the PCIe multiplexer/switch 34 in order to direct an additional 8 lanes to two out of the three PCIe devices 20.

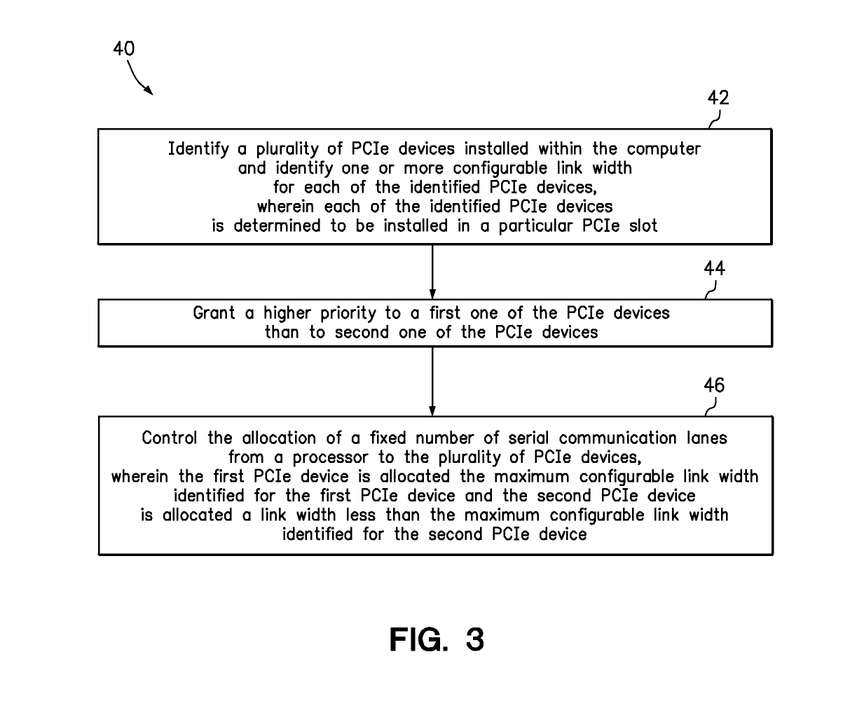

FIG. 3 is a flowchart of a method 40 in accordance with one embodiment of the present invention. The method is preferably executed by a supervisory controller, such as a baseboard management controller, within a computer, such as a server. In step 42, the supervisory controller identifies a plurality of PCIe devices installed within the computer and identifies one or more configurable link width for each of the identified PCIe devices, wherein each of the identified PCIe devices is determined to be installed in a particular PCIe slot. In step 44, the supervisory controller grants a higher priority to a first one of the PCIe devices than to second one of the PCIe devices. Then, in step 46, the supervisory controller controls the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
a supervisory controller within a computer identifying a plurality of PCIe devices installed within the computer and identifying one or more configurable link width for each of the identified PCIe devices, wherein each of the identified PCIe devices is determined to be installed in a particular PCIe slot;
the supervisory controller granting a higher priority to a first one of the PCIe devices than to a second one of the PCIe devices; and
the supervisory controller controlling the allocation of a fixed number of serial communication lanes from a processor to the plurality of PCIe devices, wherein the first PCIe device is allocated the maximum configurable link width identified for the first PCIe device and the second PCIe device is allocated a link width less than the maximum configurable link width identified for the second PCIe device.

2. The method of claim 1, wherein the supervisory controller identifies the plurality of PCIe devices and identifies one or more configurable link width for each of the identified PCIe devices by reading the vital product data of the PCIe devices.

3. The method of claim 1, wherein the supervisory controller is a baseboard management controller.

4. The method of claim 1, wherein the supervisory controller controls the allocation of serial communication lanes from the processor to the plurality of PCIe devices by providing a signal on a select line to a multiplexer, wherein the multiplexer has serial communication inputs from the processor and serial communication outputs to the PCIe slots where the PCIe devices are installed.

5. The method of claim 1, wherein there are fewer serial communication lanes from the processor to the multiplexer than from the multiplexer to the PCIe slots.

6. The method of claim 1, further comprising:
the supervisory controller changing the allocation of serial communication lanes in response to changing conditions, configurations, or performance requirements.

7. The method of claim 1, wherein the supervisory controller controls the allocation of serial communication lanes during boot of the computer.

8. The method of claim 7, wherein the supervisory controller runs a basic input output system that identifies the plurality of PCIe devices and controls the allocation of serial communication lanes.

9. The method of claim 1, further comprising:
the supervisory controller obtaining vital product data from the installed PCIe devices and allocating the serial communication lanes to the installed PCIe devices in response to the vital product data.

10. The method of claim 9, further comprising:
determining that the vital product data indicates that first and second installed PCIe devices provide a redundant resource;
determining that the vital product data indicates that the first PCIe device can provide greater performance than the second PCIe device; and
allocating more serial communication lanes to the first PCIe device than to the second PCIe device.

11. The method of claim 9, further comprising:
determining that the vital product data indicates that first and second installed PCIe devices provide a redundant resource;
determining that the vital product data indicates that the first PCIe device can provide greater performance than the second PCIe device; and
giving higher priority to allocation of serial communication lanes to the first PCIe device than to the second PCIe device.

12. The method of claim 11, wherein the first and second PCIe devices are both Ethernet Adapters.

13. The method of claim 1, further comprising:
detecting the presence of heat-generating devices in the computer, wherein the heat-generating devices are selected from a processor, memory and hard disk drive;
determining whether a first PCIe device is installed in a PCIe slot having a position directly downstream in an air flow direction from one or more of the heat-generating devices; and
in response to determining that the first PCIe device is installed downstream of one or more of the heat-generating devices, reducing a number of serial communication allocated to the first PCIe device and increasing a number of serial communication lanes allocated to a second PCIe device installed in a PCIe slot that is not directly downstream in the air flow direction from one or more of the heat-generating devices.

14. The method of claim 1, further comprising:
detecting the presence of heat-generating devices in the computer, wherein the heat-generating devices are selected from a processor, memory and hard disk drive;
determining whether a first PCIe device is installed in a PCIe slot having a position in a downstream air flow direction from the heat-generating devices;
using vital product data from the heat-generating devices to predict whether the first PCIe device will receive air flow having a temperature greater than a temperature setpoint as a result of the operation of one or more of the heat-generating devices; and
in response to determining that the first PCIe device received air flow having a temperature greater than the temperature setpoint, reducing a number of serial communication lanes allocated to the first PCIe device and increasing a number of serial communication lanes allocated to a second PCIe device installed in a PCIe slot where the air flow is predicted to have a temperature less than the temperature setpoint.

15. The method of claim 14, further comprising:
using vital product data from the first PCIe device to determine cooling requirements of the first PCIe device.

16. The method of claim 1, further comprising:
measuring the temperature of a first PCIe device in the computer; and
determining whether the temperature of the first PCIe device is greater than a temperature setpoint; and
in response to determining that the first PCIe device has a temperature greater than the temperature setpoint, reducing a number of serial communication lanes allocated to the first PCIe device and increasing a number of serial communicaton lanes allocated to a second PCIe device.

17. The method of claim 16, further comprising:
in response to determining that the first PCIe device has a temperature that is now less than the temperature setpoint, increasing a number of serial communication lanes allocated to the first PCIe device and reducing a number of serial communicaton lanes allocated to a second PCIe device.

18. The method of claim 1, further comprising:
measuring the temperature of each PCIe device in the computer;
identifying which of the PCIe devices has the highest temperature; and
in response to determining that a first PCIe device has the highest temperature, reducing a number of serial communication lanes allocated to the first PCIe device and increasing a number of serial communication lane allocated to one or more other PCIe devices in the computer.

19. The method of claim 1, further comprising:
detecting that a first PCIe device has been throttling; and
in response to detecting that the first PCIe device has been throttling, reducing a number of serial communication lanes allocated to the first PCIe device and increasing a number of serial communication lane allocated to one or more other PCIe devices in the computer.

20. The method of claim 1, further comprising:
detecting a change in the PCIe devices that are installed in the computer; and
the supervisory controller changing the allocation of serial communication lanes in response to the change in the PCIe devices.
